(19) United States
(12) Patent Application Publication
(10) Pub. No.: US 2009/0136025 A1
(43) Pub. Date: May 28, 2009

(54) Method for scalarly multiplying points on an elliptic curve

(76) Inventors: Anton Kargl, Munchen (DE); Bernd Meyer, Munchen (DE)

Correspondence Address: STAAS & HALSEY LLP, SUITE 700, 1201 NEW YORK AVENUE, N.W., WASHINGTON, DC, 20005, US

(21) Appl. No.: 11/991,181

(22) PCT Filed: Jul. 11, 2006
(86) PCT No.: PCT/EP2006/064099

§ 371 Date: Feb. 28, 2008

(30) Foreign Application Priority Data
Aug. 30, 2005 (DE) 102005041102.9

(51) Int. Cl. H04L 9/30; H04L 9/28

(52) U.S. Cl. 380/30; 380/28

(57) ABSTRACT

A method performs scalar multiplication of points on an elliptic curve by a finite expandable field K of a first field Fₚ of a p>3 characteristic, wherein said characteristic p has low Hamming weight and the expandable field has a polynomF(X)+X^{d}−2 of order d in the polynomial representation thereof.

### CROSS REFERENCE TO RELATED APPLICATIONS

This application is based on and hereby claims priority to German Application No. 10 2005 041 102.9 filed on Aug. 30, 2005 and PCT Application No. PCT/EP2006/064099 filed on Jul. 11, 2006, the contents of which are hereby incorporated by reference.

### BACKGROUND OF THE INVENTION

The invention relates to a method for scalar multiplication of points on an elliptic curve, in particular of elliptic curves over a finite extension field K of a prime field Fₚ with a characteristic p>3.

In cryptography, a distinction is drawn between symmetric and asymmetric methods. Symmetric methods use only one secret key for both encryption and decryption. The key must be distributed to both communication users via a secure channel. In the case of the asymmetric methods, two keys are used, one being public and one being private. The public key can be distributed to all users without jeopardizing the security of the data exchange. The key exchange is therefore less problematic in the case of asymmetric methods than in the case of symmetric methods. Asymmetric methods are disadvantageous in that they are about a hundred to a thousand times slower than comparable symmetric methods.

Elliptic curves have been used in asymmetric cryptography methods since 1985. The main advantage of cryptography based on elliptic curves is that in comparison with other methods, e.g. RSA, smaller keys can be used while nonetheless achieving the same level of security. A key length of 160 bits has the same level of security against attacks as a key of 1,024 bits in the case of the RSA method. Of all the methods which are currently known, elliptic curve cryptography offers the highest security per bit of the key. Elliptic curve cryptography is therefore particularly suitable for channels having a very limited bandwidth. It is however disadvantageous that the encryption and decryption is more computer-intensive than in the case of other methods. For application in cryptographic methods, it is therefore important to ensure optimal selection of the parameters of the cryptographic system.

Let K be a finite field of the characteristic p>3 and a, bεK. An elliptic curve over the field K is the zero set of the equation y²=x³+ax+b, where 4a³+27b²·0. Including the infinitely distant point as a neutral element, elliptic curves are additive groups. Let G⊂E be a subgroup of prime order. Each non-trivial point PεG is then a generator of P. It follows that each point QεG is the result of a scalar multiplication Q=sP, where sε{0, . . . , ord(P)−1}. If the scalar s is a positive integer, the scalar multiplication corresponds to the s-fold repeated addition of a point P to itself.

Scalar multiplication is currently a mathematical one-way function for curves having specific attributes. It can be calculated in polynomial time, but can only be reversed in exponential time according to the current related art. The reversal of the scalar multiplication on elliptic curves is also called the discrete logarithm problem (ECDLP) and is the mathematical foundation for cryptographic systems that are based on elliptic curves. The currently known methods for calculating discrete logarithms on elliptic curves which are suitable for cryptography have the complexity O(2^{0,5n}), where n is the binary length of the order of G⊂E. In order to satisfy the current security requirements, selection of a bit length of at least n>160 is recommended.

The scalar multiplication of a point P is usually implemented by addition and doubling of points on the elliptic curve. The calculation rule for the addition and the doubling includes of elementary operations on elements from the field K. For an effective implementation of the scalar multiplication, an optimized arithmetic is required in the field K.

The most important factor when selecting the underlying field K is the architecture of the available hardware platform. If long-number arithmetic is available on the hardware platform and if coprocessors are integrated for accelerating the arithmetic in the field K, prime fields can be used for the field K. Smart cards including coprocessors and long-number arithmetic can process e.g. elliptic curves including prime numbers having bit lengths of 160 to 600 bits very effectively.

By contrast, in hardware environments which do not feature any special computing units, e.g. embedded systems having bus widths of only 8 or 16 bits and without a coprocessor, the long-number arithmetic must first be implemented by corresponding software instructions. The cryptographic methods must therefore be realized entirely in software, and can only be optimized with difficulty or with a large amount of experience.

The performance of such software solutions for scalar multiplication can be significantly increased if it is possible to exploit the optimization possibilities provided by the hardware, e.g. the SSE2 unit of a Pentium 4 processor or the concurrent addition and multiplication of a signal processor.

Alternatively, for selecting a prime field, extension fields of a prime field Fₚ can be selected for the field K. With the aid of smaller prime numbers p having binary lengths of only 20 to 30 bits and an irreducible polynomial of degree d, it is possible to construct a smaller field Fₚ. In this case the field elements of an extension field are polynomials whose coefficients also derive from the field Fₚ, i.e. are polynomials. In this way, despite the smaller prime numbers p, it is possible to achieve a high effective bit number which then allows a sufficiently high level of security. The required polynomial arithmetic can thus be adapted to the bus width of the relevant processor, such that the arithmetic operations available in the relevant processor are optimally utilized and no long-number arithmetic is required. In the case of polynomial arithmetic, as when multiplying two n-bit numbers, n² multiplications are required. However, polynomial arithmetic has the advantage that the total number of operations can be reduced to a far greater extent as a result of utilizing special algorithms.

When two polynomials are multiplied and the result is a polynomial of maximal degree 2d−2, the polynomial must be reduced in order to return to the field. Firstly the coefficients of the polynomial modulo p are reduced in the finite field Fₚ, secondly the polynomial itself modulo irreducible polynomial is reduced.

By skillful selection of the extension field Fₚ, the overhead for both types of reduction can be minimized. Optimal extension fields (OEF) over prime field Fₚ having a characteristic p>3 and a polynomial representation of maximal degree d−1 are characterized by two main attributes in this case:
1. The prime number p is a pseudo-Mersenne prime number in the form p=2ⁿ±c, where log(c)<n/2. This attribute allows a rapid reduction in the field Fₚ.
2. There exists an irreducible polynomial F(X)=X^{d}−wεFₚ[X]. This attribute allows a rapid reduction in the polynomial ring Fₚ[X], since the coefficients which must be reduced can be reduced by a multiplication and an addition in Fₚ.

Furthermore, the optimal extension fields can be of Type 1 or Type 2:

Type 1: for the prime number p, it applies that p=2ⁿ±1, i.e. c=1.

Type 2: for the irreducible polynomial F(X), it applies that F(X)=X^{d}−2, i.e. w=2.

It can be proven mathematically that an optimal extension field is either of Type 1 or Type 2, but cannot possess both attributes simultaneously. The Type 1 optimal extension field allows an efficient arithmetic in the prime field Fₚ, while the Type 2 optimal extension field allows an efficient reduction in the polynomial ring Fₚ[X]. In both cases it cannot be ruled out that multiplication with elements of the prime field Fₚ must be carried out during the reduction in Fₚ or in the polynomial ring Fₚ[X].

If the field K is a prime field Fₚ, the reduction of products from elements of the prime field Fₚ can be accelerated by the selection of special prime numbers p. The number of required operations for a multiplication does not depend solely on the number of digits of the two factors, but is dependent to a greater extent on the Hamming weights of their representation. The Hamming weight of a number Z is understood to mean the number of set bits of Z. The Hamming weight of 11101 is four, for example. By skillful representation of numbers it is possible to reduce computing operations when multiplying two numbers: The number 63 in binary form has the representation 111111 with the Hamming weight 6. Multiplication by a power of 2 is achieved by shifting to the left, and therefore in this case a total of 5 shift operations and 5 additions are required. However, the number 63 can also be represented as 2⁶−1. In this representation, it has a Hamming weight of only 2, and therefore a multiplication by 63 can be done by one left shift by 6 bit positions and one subtraction. By contrast, in the case of a multiplication by the number 10, two shift operations and one addition are required despite the smaller number of digits. The complexity of a multiplication is therefore heavily dependent on its Hamming weight. In a list of recommended elliptic curves over prime fields of the National Institute of Standards and Technology (NIST, USA), care has been taken to ensure that the prime number has a representation in the form

p=2ⁿ±2^{m}±1 with the Hamming weight 3, and therefore allows an efficient reduction.

The irreducible polynomial X^{d}−2 has an optimal form with regard to the reduction. It contains only two terms, X^{d} and a constant, additive factor. This factor, 2, is also optimally selected, since the coefficient which is to be reduced need only be shifted by one bit in order to multiply it by 2. The prime number in the representation p=2ⁿ±1 is likewise optimal with regard to the reduction, since only one additive element of 2ⁿ is present. Unfortunately it is not possible to combine both types together, and therefore an appraisal of the effort involved is always required when choosing the extension field.

The coefficients a and b of an elliptic curve which is defined over an extension field are generally polynomials. In the case of a Koblitz curve, a and b lie in the base field and are polynomials of the degree zero. The exponentiation by p of a point lying on the curve maps said point back onto the same curve in the finite field as a result of the Frobenius homomorphism. If a and b are polynomials, however, the point is mapped onto another curve. The Frobenius endomorphism on the elliptic curve is in the endomorphism ring, i.e. in the case of Koblitz curves it is possible to represent all scalars in relation to the Frobenius endomorphism, and thus derive a very rapid scalar multiplication algorithm.

### SUMMARY

One potential object is therefore to specify an efficient implementation of the scalar multiplication of points on an elliptic curve, over a finite extension field having the characteristic p>3, in software on a standard processor without additional coprocessors.

The inventors propose a method for scalar multiplication of points on an elliptic curve over a finite extension field K of a prime field Fₚ having a characteristic p>3, wherein the scalar multiplication is carried out within a cryptographic algorithm for an encryption of a message, a decryption of a message, a signature generation from a message or a signature verification calculation from a message, and wherein the characteristic p has a Hamming weight≦4 and the extension field K in polynomial representation has an irreducible polynomial F(X)=X^{d}−2 of the degree d. The optimal extension field is therefore of Type 2 and has optimal reduction attributes with regard to the reduction in the polynomial ring Fₚ[X]. Since optimal extension fields of Type 1 and Type 2 are mutually exclusive, a representation of the prime number in the form p=2ⁿ±1 is not possible. In order nonetheless to allow an efficient arithmetic in the prime field Fₚ, it is necessary for the prime number p to have a low Hamming weight. As a result of the low Hamming weight in the binary representation, the number of computing operations is greatly reduced and the calculation of the scalar multiplication is accelerated.

According to an advantageous embodiment, the characteristic p has a Hamming weight of 3. A Hamming weight of less than 3 produces an optimal extension field of Type 1. However, since an optimal extension field of Type 2 has already been selected, this is not possible. If the Hamming weight is 4 or more, additional summands are produced which affect the efficiency of the algorithm for the scalar multiplication.

According to an advantageous embodiment, the characteristic is selected such that p=2ⁿ±2^{m}±1, where n and m are natural numbers. If the characteristic is selected in this form, it automatically has a Hamming weight of 3. All operations can be realized efficiently by shifting the bit positions and addition or subtraction.

According to an advantageous embodiment, the degree d of the irreducible polynomial is a prime number. If d were an even number, this would result in a binomial formula by which the irreducible polynomial could be reduced. If the degree d is a prime number, it is possible to prevent known attacks which are possible if the degree d is not a prime number.

According to an advantageous embodiment, the elliptic curve is given by y²=x³+ax+b, where 4a³+27b²≠0. This does not represent a limitation, as the method can also be applied to other curves. The condition for the coefficients a and b must apply in order that the elliptic curve does not include any singular points, since it would otherwise be unsuitable for cryptography applications.

According to an advantageous embodiment, the elliptic curve is a Koblitz curve. Koblitz curves allow a rapid scalar multiplication by the Frobenius endomorphism over the field Fₚ.

According to an advantageous embodiment, the scalar multiplication is carried out by a Frobenius endomorphism in a power series representation of the scalar. The scalar multiplication can then be implemented as a sum of shorter scalar multiplications.

According to an advantageous embodiment, the powers of the power series are calculated and stored in advance. The efficiency of the scalar multiplication algorithm can thus be increased further.

According to an advantageous embodiment, the bit length of the characteristic p and the degree d is adapted to the processor on which the scalar multiplication is carried out. In the case of a processor having a word width of 8 bits, the prime number p can include 5 to 6 bits, thereby allowing a representation of prime numbers up to 31. In order to allow sufficient security, the degree d of the irreducible polynomial must then be selected such that it is higher than in the case of a prime number having a greater bit length. In order to realize a field having at least 160 bits, a degree of d=23 or 29 is required. In the case of a processor having a word width of 16 bits, characteristics p having bit lengths of 12 to 13 bits can be used and the degree of the irreducible polynomial can then be smaller, e.g. d=11.

According to an advantageous embodiment, the characteristic p and the degree d are selected such that the arithmetic operations which are provided for the bus width of the processor can be used directly for the scalar multiplication. In this way it is possible to store intermediate results in the case of multiplications, without a reduction being necessary in relation to the characteristic p. Moreover, no implementation for long-number arithmetic is necessary.

According to an advantageous embodiment, parts of the computing operations of the scalar multiplication are carried out in parallel by a Streaming Single Instruction Multiple Data (SIMD) Extension instruction set (SSE). As a result of parallel processing and the utilization of further optimization possibilities available on the hardware platform, the required computing time can be dramatically reduced even without coprocessors.

The above-described methods are utilized in an asymmetric cryptography application. These applications can enable key exchange, digital signatures, etc., wherein the computing time and the requirement in terms of hardware remain at an acceptable level for the user.

The invention is described in greater detail below with reference to exemplary embodiments.

### DETAILED DESCRIPTION OF THE PREFERRED EMBODIMENTS

In order to accelerate the calculation of scalar multiplication, it is necessary to optimize an elliptic curve over an optimal extension field and to optimize the field arithmetic according to the available hardware platform. This is accomplished by an optimization relative to the computing overhead that is required if the optimal extension field does not satisfy one of the conditions of Type 1 or of Type 2. It is evident that if an optimal extension field of Type 2 is selected, it is possible to adequately compensate for the consequential non-optimal form relative to Type 1 by a skillful selection of the prime number p. If the irreducible polynomial F(X) is not optimal, however, greater computing overhead is indicated since this polynomial often impacts on the calculation and has a multiplicity of coefficients corresponding to the degree d.

In order to compensate for the non-optimal form of the prime number relative to Type 1, therefore, a number which has a very low Hamming weight in binary representation is selected as prime number p. Prime numbers of the form p=2ⁿ±2^{m}±1 have the smallest possible Hamming weight, i.e. 3. The additional summand 2^{m} has less impact on the computing time than a non-optimal reduction polynomial.

The prime number p is further selected such that as many intermediate results as possible can be stored in registers without the need to reduce relative to the prime number p. The additive constant can then be tolerated without significant disadvantage relative to the computing time, since reduction is only necessary once, at the end.

In the exemplary embodiments, a 32-bit Pentium 4 processor with an SSE2 unit is used as a target platform. In order to get by without long-number arithmetic or a coprocessor, the bit length of the prime number p is selected to be between 20 and 30 bits. In comparison with the recommended bit length of 160 bits, this represents a reduction by a factor of five to eight.

The reduction polynomial is selected as F(X)=X^{d}−w, where

d=11 and w=2. The prime number is selected as p=2²⁹−2⁹+1, where n=29, m=9 and c=511. The prime number p therefore has a bit length of only 29 bits.

The multiplication by c=511, which is required for the reduction in the definition of the optimal extension field, can then be realized very effectively, due to the Hamming weight of 3, using the rapid operations of bitwise shifting, addition and subtraction.

By virtue of the proposed method it is now possible to find optimal extension fields which combine the advantages of Type 1 and Type 2 optimal extension fields. The reduction of products of elements in the prime field Fₚ and the reduction of products in the polynomial ring over Fₚ can be performed without using multiplication commands of the processor. Due to the low Hamming weight, the multiplication by the additive constant c=±2^{m}±1 can be performed by a shift operation and a subtraction or addition. A reduction modulo p can be performed by just four shift operations, two subtractions and two additions. Furthermore, all intermediate sums of partial products of the coefficients of the operands can be stored in a 64-bit register without overflow. The reduction modulo p takes place just once at the end of the calculation of the coefficients of the product.

Using the SSE2 (Streaming SIMD Extension 2) assembler instruction set from Intel, it is possible for parts of the field arithmetic to be processed in parallel over the field Fₚ in the case of a Pentium 4 processor. The Single Instruction Multiple Data (SIMD) concept and the 128-bit register allow the simultaneous calculation of two partial products, as illustrated in the following program segment.
movd xmm0, [edi]; load operand a
punpcklqdq xmm0, xmm0; duplicate operand a
movdqu xmm6, [esi]; load operands b and c
pmuludq xmm6, xmm0; compute a*b and a*c
paddq xmm1, xmm6; add a*b and a*c to previous results
   The following program segment exploits the skilful representation of p=2²⁹−2⁹+1 having a low Hamming weight, in order to reduce two intermediate results simultaneously:
movdqa xmm7, xmm1; mask both lower 29-bit parts
pand xmm1, [mask]
psrlq xmm7, 29; shift upper parts 29 bits right
psubq xmm1, xmm7; subtract
psllq xmm7, 9; shift upper parts 9 bits left
paddq xmm1, xmm7; add
movdqa xmm6, xmm1; repeat the reduction step
pand xmm1, [mask]
psrlq xmm6, 29
psubq xmm1, xmm6
psllq xmm6, 9
paddq xmm1, xmm6
mask dd 0x1fffffff, 0x00000000, 0x1fffffff, 0x00000000

Using SSE2 instructions which are applied to 4 double words it is even possible to calculate and reduce 4 coefficients simultaneously as part of the addition and subtraction in Fₚ.

A Koblitz curve is selected as an elliptic curve, where y²=x³+ax+b modulo p with the parameters a=468383287 and b=63579974. The coefficients a and b were determined at random and are of the degree 0, such that an exponentiation by p of a point maps said point back onto the same curve. It is thus possible to use the Frobenius endomorphism for a very fast scalar multiplication algorithm. For the purpose of further acceleration, the necessary powers of the number 2 are calculated in advance and stored in tables.

The optimal extension fields can also be selected in a similar manner for hardware platforms having other bus widths. The prime number p is selected such that on the one hand an optimal reduction polynomial of Type 2, i.e. X^{d}−2, is provided and on the other hand the prime number p has a minimal Hamming weight and hence the fewest possible summands are present in the binary representation. For a 16-bit processor, the prime number p has a bit length of 11 or 13 bits, for example.

As a result of using the optimal extension field described above and skillful selection of the prime number p, the computing time for the scalar multiplication of points on elliptic curves is reduced and therefore cryptographic methods which utilize elliptic curves over optimal extension fields can be executed more quickly. Since the method for scalar multiplication is additionally scalable by an appropriate selection of the bit length of the prime numbers, and can therefore be adapted to different processor bus widths, it can also be implemented on the widest variety of hardware platforms. Asymmetric methods based on elliptic curves can be implemented with low computing times in particular on hardware platforms which do not support long-number arithmetic or include coprocessors.

The system also includes permanent or removable storage, such as magnetic and optical discs, RAM, ROM, etc. on which the process and data structures of the present invention can be stored and distributed. The processes can also be distributed via, for example, downloading over a network such as the Internet. The system can output the results to a display device, printer, readily accessible memory or another computer on a network.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 69 USPQ2d 1865 (Fed. Cir. 2004).

1-13. (canceled)

14. A scalar multiplication method for encrypting a message in a computer, comprising:
inputting a scalar value;
inputting message data relating to points on an elliptic curve;
performing scalar multiplication of the points on the elliptic curve over a finite extension field K of a prime field Fₚ having a characteristic p>3, wherein
p is a characteristic having a Hamming weight≦4, and
K is an extension field in a polynomial representation and has an irreducible polynomial F(X)=X^{d}−2 of the degree d;
encrypting the message data based on the scalar multiplication to thereby produce a result; and
outputting the result to a display device, printer, readily accessible memory or another computer on a network.

15. The method as claimed in claim 14, wherein
the characteristic p has a Hamming weight of 3.

16. The method as claimed in claim 15, wherein
the characteristic p=2ⁿ±2^{m}±1, where n and m are natural numbers.

17. The method as claimed in claim 14, wherein
the degree d of the irreducible polynomial is a prime number.

18. The method as claimed in claim 14, wherein
the elliptic curve is given by
y²=x³+ax+b, where 4a³+27b²≠0.

19. The method as claimed in claim 18, wherein
the elliptic curve is a Koblitz curve.

20. The method as claimed in claim 19, wherein
the scalar multiplication is carried out by a Frobenius endomorphism in a power series representation of the scalar value.

21. The method as claimed in claim 20, wherein
the power series has powers calculated and stored in advance.

22. The method as claimed in claim 14, wherein
the characteristic p and the degree d both have a bith length adapted to a processor on which the scalar multiplication is carried out.

23. The method as claimed in claim 22, wherein
the processor has a bus width, and
the characteristic p and the degree d are selected such that arithmetic operations which are provided for the bus width of the processor can be used directly for the scalar multiplication.

24. The method as claimed in claim 22, wherein
the characteristic p and the degree d are selected such that all coefficients of intermediate products of a modular multiplication over the extension field can be stored without overflow in a register of the processor.

25. The method as claimed in claim 14, wherein
there are at least two computing operations in the scalar multiplication, and
the at least two computing operations of the scalar multiplication are executed in parallel by a Streaming Single Instruction Multiple Data Extension instruction set.

26. A use of the method as claimed in claim 14 wherein the message data is encrypted in an asymmetric cryptography method using public and private keys.

27. A scalar multiplication method for decrypting a message in a computer, comprising:
inputting a scalar value;
inputting message data related to points on an elliptic curve;
performing scalar multiplication of the points on the elliptic curve over a finite extension field K of a prime field Fₚ having a characteristic p>3, wherein
p is a characteristic having a Hamming weight≦4, and
K is an extension field in a polynomial representation and has an irreducible polynomial F(X)=X^{d}−2 of the degree d;
decrypting the message data based on the scalar multiplication to thereby produce a result; and
outputting the result to a display device, printer, readily accessible memory or another computer on a network.

28. The method as claimed in claim 27, wherein
the characteristic p has a Hamming weight of 3.

29. The method as claimed in claim 28, wherein
the characteristic p=2ⁿ±2^{m}±1, where n and m are natural numbers.

30. The method as claimed in claim 27, wherein
the degree d of the irreducible polynomial is a prime number.

31. The method as claimed in claim 27, wherein
the elliptic curve is given by
y²=x³+ax+b, where 4a³+27b²≠0.

32. A scalar multiplication method for a computer-operated cryptography process, comprising:
inputting a scalar value;
inputting message data related to points on an elliptic curve;
performing scalar multiplication of the points on the elliptic curve over a finite extension field K of a prime field Fₚ having a characteristic p>3, wherein
p is a characteristic having a Hamming weight≦4, and
K is an extension field in a polynomial representation and has an irreducible polynomial F(X)=X^{d}−2 of the degree d;
generating a signature from the message data based on the scalar multiplication to thereby produce a result; and
outputting the result to a display device, printer, readily accessible memory or another computer on a network.

33. A scalar multiplication method for a computer-operated cryptography process, comprising:
inputting a scalar value;
inputting message data related to points on an elliptic curve;
performing scalar multiplication of the points on the elliptic curve over a finite extension field K of a prime field Fₚ having a characteristic p>3, wherein
p is a characteristic having a Hamming weight≦4, and
K is an extension field in a polynomial representation and has an irreducible polynomial F(X)=Xd−2 of the degree d;
verifying a signature from the message data based on the scalar multiplication to thereby produce a result; and
outputting the result to a display device, printer, readily accessible memory or another computer on a network.
